(19) United States
(12) Patent Application Publication
(10) Pub. No.: US 2021/0374622 A1
(43) Pub. Date: Dec. 2, 2021

(54) SERVER DEVICE, PROGRAM, AND OPERATION METHOD OF SERVER DEVICE

(71) Applicant: TOYOTA JIDOSHA KABUSHIKI KAISHA, Toyota-shi (JP)

(72) Inventor: Daiki KANEICHI, Shinagawa-ku (JP)

(73) Assignee: TOYOTA JIDOSHA KABUSHIKI KAISHA, Toyota-shi (JP)

(21) Appl. No.: 17/225,585

(22) Filed: Apr. 8, 2021

(30) Foreign Application Priority Data
May 29, 2020 (JP) 2020-094757

(51) Int. Cl. G06Q 10/02; G01C 21/34; G01C 21/36; G06Q 50/30

(52) U.S. Cl. CPC G06Q 10/025; G01C 21/343; G06Q 50/30; G01C 21/3492; G01C 21/3697; G01C 21/3415

(57) ABSTRACT

A server device includes a communication unit, and a control unit configured to transmit and receive information to and from a terminal device by the communication unit. The control unit is configured to receive, from the terminal device, a request for vehicle dispatch including a specified section where a user rides a vehicle, transmit, to the terminal device, information on a first fare determined before the user rides the vehicle and information on a second fare estimated before the user rides the vehicle to cause the terminal device to output information for prompting the user to select the first fare or the second fare, and dispatch the vehicle when any one of the fares is selected. The first fare and the second fare are associated with the ride.

### CROSS-REFERENCE TO RELATED APPLICATION

This application claims priority to Japanese Patent Application No. 2020-094757 filed on May 29, 2020, incorporated herein by reference in its entirety.

### BACKGROUND

### 1. Technical Field

The present disclosure relates to a server device, a program, and an operation method of the server device.

### 2. Description of Related Art

Japanese Unexamined Patent Application Publication No. 2002-342426 describes a technology of assigning a taxi via a communication line.

### SUMMARY

However, the related art does not sufficiently improve the vehicle dispatch service.

The present disclosure provides a server device that improves the convenience of a vehicle dispatch service.

A server device according to the present disclosure includes a communication unit, and a control unit configured to transmit and receive information to and from a terminal device by the communication unit. The control unit is configured to receive, from the terminal device, a request for vehicle dispatch including a specified section where a user rides a vehicle, transmit, to the terminal device, information on a first fare determined before the user rides the vehicle and information on a second fare estimated before the user rides the vehicle to cause the terminal device to output information for prompting the user to select the first fare or the second fare, and dispatch the vehicle when any one of the first fare and the second fare is selected. The first fare and the second fare are associated with the ride.

A program of a terminal device according to the present disclosure causes, when being executed by the terminal device that communicates with a server device, the terminal device to transmit, to the server device, a request for vehicle dispatch with a specified section where a user rides a vehicle, receive, from the server device, information on a first fare determined before the user rides the vehicle and information on a second fare estimated before the user rides the vehicle, output information for prompting the user to select the first fare or the second fare, receive, from the user, an input for selecting the first fare or the second fare, and transmit, to the server device, information on the selected fare to cause the server device to dispatch the vehicle.

An operation method of a server device according to the present disclosure is an operation method of a server device that transmits and receives information to and from a terminal device. The operation method includes a step of receiving, from the terminal device, a request for vehicle dispatch with a specified section where a user rides a vehicle, a step of transmitting, to the terminal device, information on a first fare determined before the user rides the vehicle and information on a second fare estimated before the user rides the vehicle to cause the terminal device to output information for prompting the user to select the first fare or the second fare, and a step of dispatching a vehicle when any one of the fares is selected. The first fare and the second fare are associated with the ride.

With the server device and the like according to the present disclosure, it is possible to improve the convenience of the vehicle dispatch service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration example of an information processing system;

FIG. 2 is a diagram illustrating a configuration example of a terminal device;

FIG. 3 is a diagram illustrating a configuration example of a server device;

FIG. 4 is a diagram illustrating a configuration example of an in-vehicle device;

FIG. 5 is a sequence diagram illustrating an operation example of the information processing system;

FIG. 6 is a diagram illustrating coefficient examples for calculating a fare confirmed in advance; and

FIG. 7 is a diagram illustrating a display example of the terminal device.

### DETAILED DESCRIPTION OF EMBODIMENTS

An embodiment will be described hereinbelow.

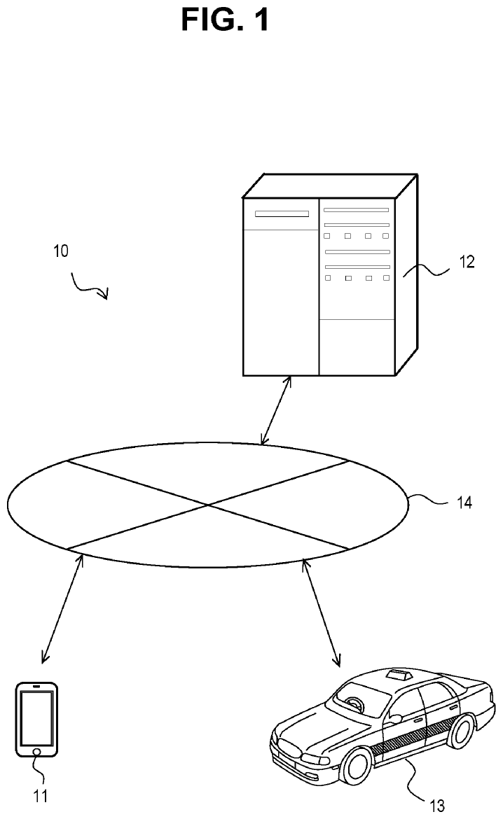

FIG. 1 is a diagram illustrating a configuration example of an information processing system according to one embodiment. An information processing system 10 includes a user terminal device 11 and a server device 12 that are connected to each other via a network 14 to establish information communication. Further, one or more taxis 13 are connected to the network 14 so as to communicate information via their respective in-vehicle devices. The taxi 13 corresponds to the “vehicle” in the present embodiment. The terminal device 11 is, for example, a mobile phone, a smartphone, a tablet, or a personal computer (PC). The server device 12 is, for example, a server device which is included in a cloud computing system or another computing system and implements a variety of functions. In the present embodiment, the server device 12 serves as a vehicle dispatch server for dispatching the taxi 13. The network 14 is, for example, the internet, but may include an ad hoc network, a LAN (Local Area Network), a MAN (Metropolitan Area Network), or another network, or a combination thereof.

In the information processing system 10, the user of the terminal device 11 uses the vehicle dispatch service provided by the server device 12 by executing a vehicle dispatch application installed on the terminal device 11. The server device 12 transmits an instruction to the taxi 13 instructing the taxi to go to a location of the terminal device 11, for example, in response to a request from the terminal device 11. In particular, the server device 12 receives, from the terminal device 11, a request for vehicle dispatch including a specified section where the user ride the vehicle (from a boarding point to an alighting point), and transmits, to the terminal device 11, information on a first fare determined before the user rides the vehicle and information on a second fare estimated before the user rides the vehicle, the first fare and the second fare being associated with the ride. The terminal device 11 outputs information for prompting the user to select the first fare or the second fare. When any one of the fares is selected, the selection is transmitted to the server device 12, and the server device 12 dispatches the vehicle in accordance with the selection.

The first fare is a fare calculated by a predetermined method based on the section information. The first fare is, for example, a fare confirmed in advance which is obtained by calculating a fare based on a distance from the boarding point to the alighting point, and multiplying the calculation result by a coefficient depending on the period of the time. Hereinbelow, a case where the first fare is a fare confirmed in advance will be described as one example, but the first fare of the present disclosure can include any fare as long as it is confirmed before the user rides the vehicle based on the section information, regardless of the calculation method.

The second fare is a previously estimated amount of a pay-as-you-go fare determined based on a time for which the user rides the vehicle and a distance at which the user actually rides the vehicle. The pay-as-you-go fare is, for example, a fare calculated based on both time and distance, which is basically calculated based on a distance from the boarding point to the alighting point, and further, by adding a fare calculated based on a time when a traveling speed is equal to or lower than a reference speed (for example, 10 km/h).

Since the information processing system 10 displays the fare such that the user can select either the estimated amount of the pay-as-you-go fare or the fare confirmed in advance, the user can choose any one of the fare confirmed in advance or the pay-as-you-go fare, by referring to the estimated amount of the pay-as-you-go fare. The pay-as-you-go fare varies depending on road conditions while traveling, thus it may be higher or lower than the fare confirmed in advance, but the user can predict whether it would be higher or lower by referring to the estimated amount, and can select the fare at his/her own discretion. Therefore, it is possible for the user to select the optimal fare, and the convenience of the vehicle dispatch service can be improved.

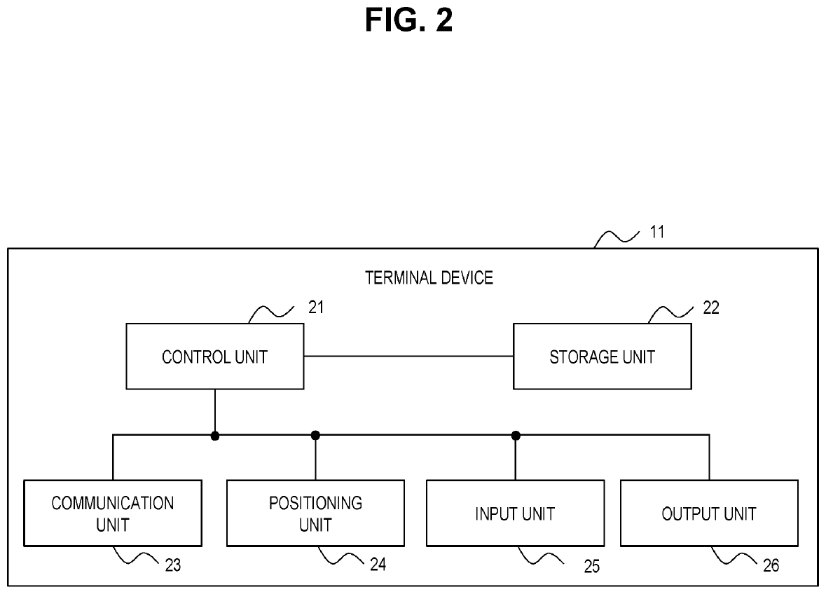

FIG. 2 is a diagram illustrating a configuration example of the terminal device 11. The terminal device 11 includes a control unit 21, a storage unit 22, a communication unit 23, a positioning unit 24, an input unit 25, and an output unit 26. The terminal device 11 is, for example, a mobile phone, a smartphone, a tablet, or a PC.

The control unit 21 includes one or more processors, one or more dedicated circuits, or a combination thereof. The processor is, for example, a general-purpose processor such as a central processing unit (CPU), or alternatively, a dedicated processor specialized for specific processing. The dedicated circuit is, for example, a field-programmable gate array (FPGA) or an application specific integrated circuit (ASIC). The control unit 21 executes information processing related to the operations of the terminal device 11 while controlling each unit of the terminal device 11.

The storage unit 22 includes one or more semiconductor memories, one or more magnetic memories, one or more optical memories, or a combination of at least two of these kinds of memories. The semiconductor memory is, for example, RAM (random access memory) or ROM (read only memory). The RAM is, for example, SRAM (static RAM) or DRAM (dynamic RAM). The ROM is for example, EEPROM (electrically erasable programmable read only memory). The storage unit 22 functions as, for example, a main storage device, an auxiliary storage device, or a cache memory. The storage unit 22 stores information used for the operations of the terminal device 11 and information acquired by the operations of the terminal device 11.

The communication unit 23 includes one or more communication interfaces. The communication interface is, for example, an interface corresponding to a mobile communication protocol such as LTE (Long Term Evolution), 4G (4th Generation) or 5G (5th Generation), or alternatively, a LAN interface. The communication unit 23 receives the information used for the operations of the terminal device 11 and transmits the information acquired by the operations of the terminal device 11. The terminal device 11 is connected to the network 14 by the communication unit 23 via a nearby router device or a mobile communication base station, and performs information communication with another device via the network 14.

The positioning unit 24 includes one or more GNSS (global navigation satellite system) receivers. The GNSS includes, for example, at least one of GPS (global positioning system), QZSS (quasi-Zenith satellite system), GLONASS (global navigation satellite system), and Galileo. The positioning unit 24 acquires location information of the terminal device 11.

The input unit 25 includes one or more input interfaces. The input interface is, for example, a physical key, a capacitance key, a pointing device, a touch screen integrated with a display, or a microphone receiving voice input. The input interface may further include a camera that captures an image or image code, or an IC card reader. The input unit 25 accepts information used for the operations of the terminal device 11, which is input as an operation by the user, and transmits the input information to the control unit 21.

The output unit 26 includes one or more output interfaces. The output interface is, for example, a display that is external or built-in and outputs information as image/video, a speaker that outputs information as audio, or alternatively, a connection interface accessible by an external output device. The display is, for example, a liquid crystal display (LCD) or an organic electro luminescence (EL) display. The output unit 26 outputs the information acquired by the operations of the terminal device 11.

The operations of the terminal device 11 are implemented by executing a program with the processor included in the control unit 21. The program can be recorded in a computer-readable recording medium. The computer-readable recording medium is, for example, a magnetic recording device, an optical disc, a magneto-optical recording medium, or a semiconductor memory. The program is, for example, distributed as being recorded on a portable recording medium such as a DVD (digital versatile disc) or a CD-ROM (compact disc). The program may be stored in a storage of the server device and transferred from the server device to another computer to distribute the program. Some or all of the operations of the terminal device 11 may be implemented by the dedicated circuit included in the control unit 21.

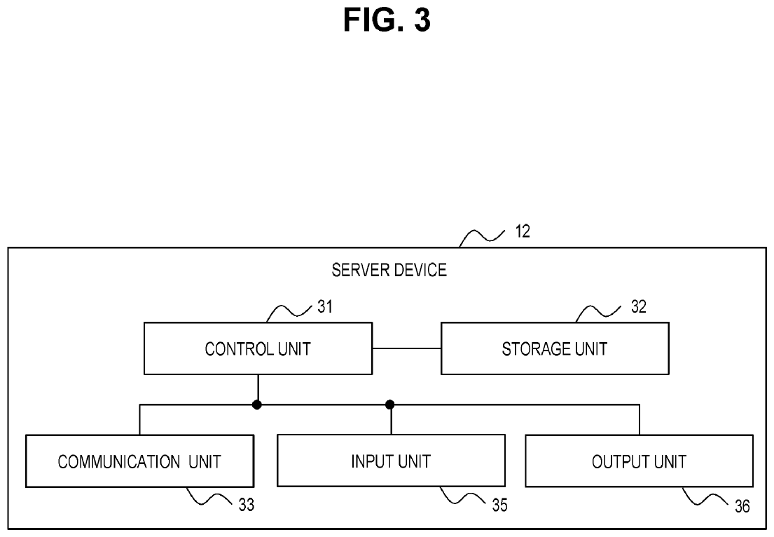

FIG. 3 illustrates a configuration example of the server device 12. The server device 12 includes a control unit 31, a storage unit 32, a communication unit 33, an input unit 35, and an output unit 36. The server device 12 is, for example, a server which is included in a cloud computing system or another computing system and implements a variety of functions.

The control unit 31 includes one or more processors, one or more dedicated circuits, or a combination thereof. The processor is, for example, a general-purpose processor (such as a CPU) or a dedicated processor specialized for specific processing. The dedicated circuit is, for example, an FPGA or an ASIC. The control unit 31 executes information processing related to the operations of the server device 12 while controlling each unit of the server device 12.

The storage unit 32 includes one or more semiconductor memories, one or more magnetic memories, one or more optical memories, or a combination of at least two of these kinds of memories. The semiconductor memory is, for example, RANI or ROM. The RAM is, for example, SRAM or DRAM. The ROM is, for example, EEPROM. The storage unit 32 functions as, for example, a main storage device, an auxiliary storage device, or a cache memory. The storage unit 32 stores information used for the operations of the server device 12 and information acquired by the operations of the server device 12.

The communication unit 33 includes one or more communication interfaces. The communication interface is, for example, a LAN interface. The communication unit 33 receives the information used for the operations of the server device 12 and transmits the information acquired by the operations of the server device 12. The server device 12 is connected to the network 14 by the communication unit 33, and performs information communication with another device via the network 14.

The input unit 35 includes one or more input interfaces. The input interface is, for example, a physical key, a capacitance key, a pointing device, a touch screen integrated with a display, or a microphone receiving voice input. The input interface may further include a camera that captures an image or image code, or an IC card reader. The input unit 35 accepts information used for the operations of the server device 12, which is input as an operation by the user, and transmits the input information to the control unit 31.

The output unit 36 includes one or more output interfaces. The output interface is, for example, a display or a speaker. The display is, for example, an LCD or an organic EL display. The output unit 36 outputs the information acquired by the operations of the server device 12.

The function of the server device 12 is implemented by executing a control program with the processor included in the control unit 31. The control program is a program for causing the computer to execute processing a step included in the operations of the server device 12 such that the computer implements the function corresponding to processing of the step. That is, the control program is a program for causing the computer to function as the server device 12. Further, some or all of the functions of the server device 12 may be implemented by the dedicated circuit included in the control unit 31.

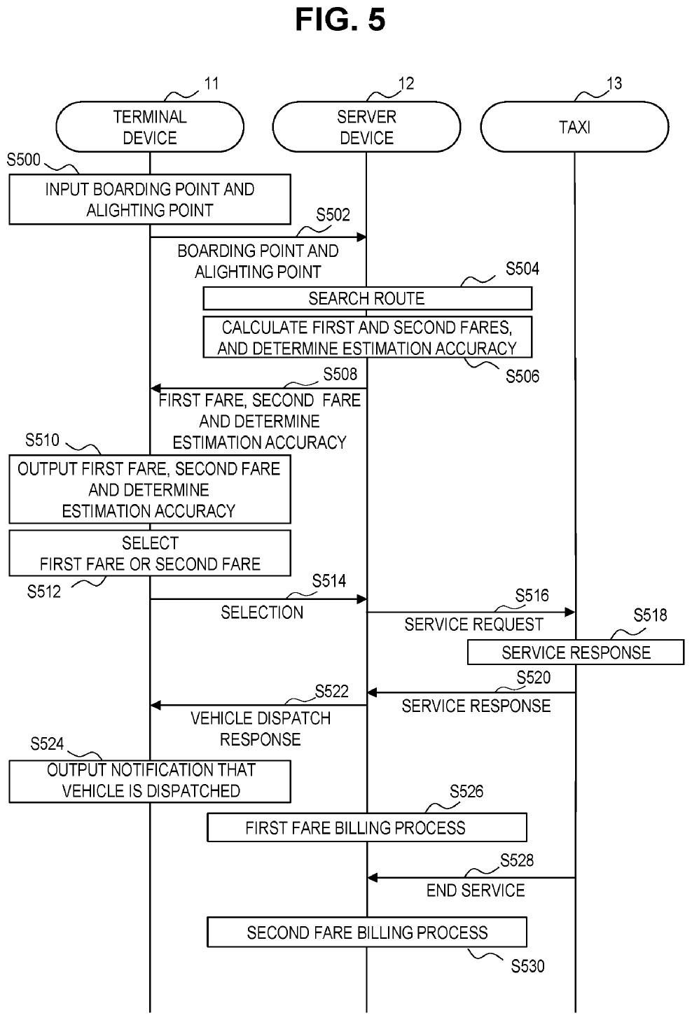

FIG. 4 shows a configuration example of an in-vehicle device 40 mounted on the taxi 13. The in-vehicle device 40 includes a control unit 41, a storage unit 42, a communication unit 43, a positioning unit 44, an input unit 45, and an output unit 46. The in-vehicle device 40 is, for example, a navigation device, a mobile phone, a smartphone, a tablet, or a PC.

The control unit 41 includes one or more processors, one or more dedicated circuits, or a combination thereof. The processor is a general-purpose processor (such as a CPU) or a dedicated processor specialized for specific processing. The dedicated circuit is, for example, an FPGA or an ASIC. The control unit 41 executes information processing related to the operations of the in-vehicle device 40 while controlling each unit of the in-vehicle device 40.

The storage unit 42 includes one or more semiconductor memories, one or more magnetic memories, one or more optical memories, or a combination of at least two of these kinds of memories. The semiconductor memory is, for example, RAM or ROM. The RAM is, for example, SRAM or DRAM. The ROM is, for example, EEPROM. The storage unit 42 functions as, for example, a main storage device, an auxiliary storage device, or a cache memory. The storage unit 42 stores information used for the operations of the in-vehicle device 40 and information acquired by the operations of the in-vehicle device 40.

The communication unit 43 includes one or more communication interfaces. The communication interface is, for example, an interface corresponding to a mobile communication protocol such as LTE, 4G or 5G. The communication unit 43 receives the information used for the operations of the in-vehicle device 40 and transmits the information acquired by the operations of the in-vehicle device 40. The in-vehicle device 40 is connected to the network 14 by the communication unit 43 via a mobile communication base station, and performs information communication with another device via the network 14.

The positioning unit 44 includes one or more GNSS receivers. The GNSS includes, for example, at least one of GPS, QZSS, GLONASS, and Galileo. The positioning unit 44 acquires location information of the taxi 13.

The input unit 45 includes one or more input interfaces. The input interface is, for example, a physical key, a capacitance key, a pointing device, a touch screen integrated with a display, or a microphone receiving voice input. The input interface may further include a camera that captures an image or image code, or an IC card reader. The input unit 45 accepts information used for the operations of the in-vehicle device 40, which is input as an operation by the user, and transmits the input information to the control unit 41.

The output unit 46 includes one or more output interfaces. The output interface is, for example, a display or a speaker. The display is, for example, an LCD or an organic EL display. The output unit 46 outputs the information acquired by the operations of the in-vehicle device 40.

The function of the in-vehicle device 40 is implemented by executing a control program with the processor included in the control unit 41. The control program is a program for causing the computer to execute processing a step included in the operations of the in-vehicle device 40 such that the computer implements the function corresponding to processing of the step. That is, the control program is a program for causing the computer to function as the in-vehicle device 40. Further, some or all of the functions of the in-vehicle device 40 may be implemented by the dedicated circuit included in the control unit 41.

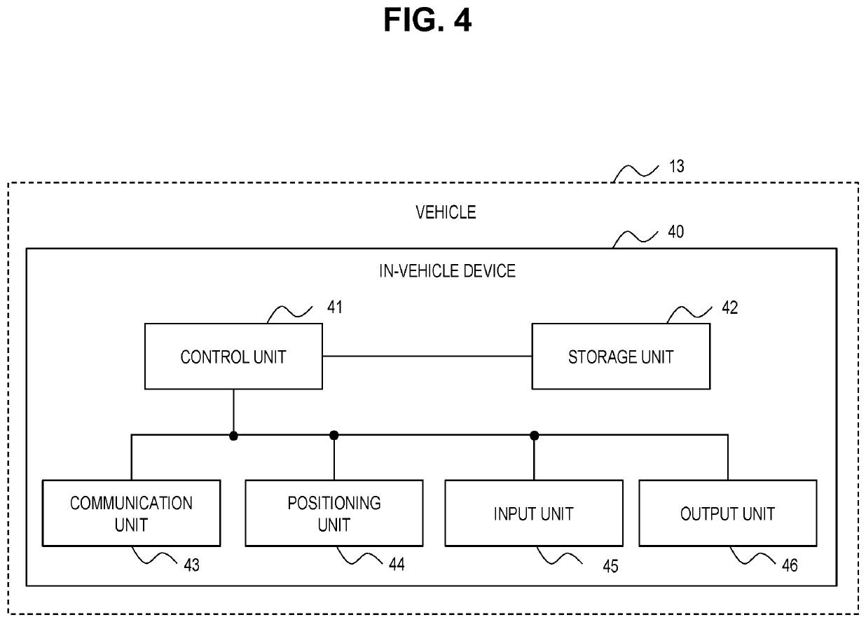

Hereinbelow, the operations executed by the terminal device 11, the server device 12 and the in-vehicle device 40 of the taxi 13 in cooperation with each other will be described referring to FIGS. 5 to 7.

FIG. 5 is a sequence diagram illustrating an operation procedure when the terminal device 11, the server device 12 and the in-vehicle device 40 of the taxi 13 operate in cooperation with each other. The procedure shown in FIG. 5 is executed when the user operates the terminal device 11 to start the vehicle dispatch application of the terminal device 11.

In step S500, the terminal device 11 accepts the boarding point and the alighting point, as input by the user. The control unit 21 of the terminal device 11 receives, for example, from the server device 12, map information corresponding to a current location of the terminal device 11, displays the map information by the output unit 26, and prompts the user to input the boarding point and the alighting point. The user inputs the boarding point and the alighting point by, for example, tapping a desired point on the map or by inputting an address. The control unit 21 accepts the input from the user via the input unit 25.

In step S502, the terminal device 11 transmits, to the server device 12, information on the boarding point and the alighting point. The control unit 21 of the terminal device 11 transmits, to the server device, the information on the boarding point and the alighting point by the communication unit 23. The control unit 31 of the server device receives the information on the boarding point and the alighting point by the communication unit 33.

In step S504, the server device 12 searches for a route from the boarding point to the alighting point. The control unit 31 of the server device 12 reads the map information from, for example, the storage unit 32, and searches for the route using the map information. The route is, for example, a route having the shortest distance.

In step S506, the server device 12 calculates a first fare and a second fare.

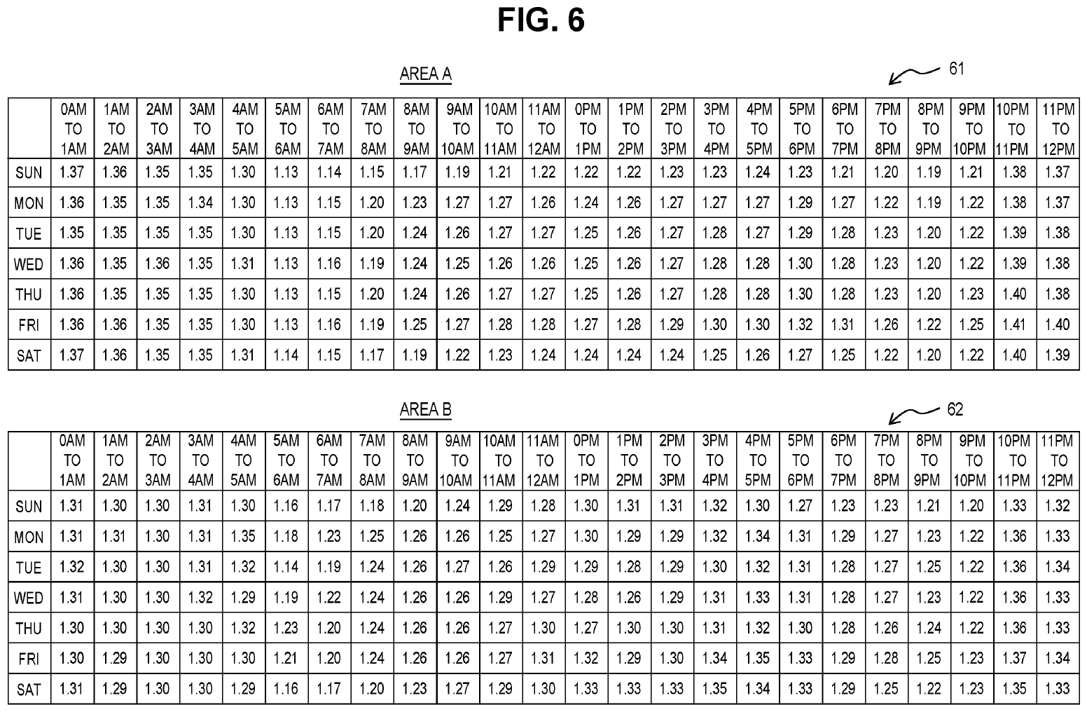

The first fare is a fare confirmed in advance. The control unit 31 of the server device 12 obtains a fare confirmed in advance by calculating a fare based on a distance of the route from the boarding point to the alighting point, and multiplying the calculation result by a coefficient depending on the period of the time. For example, the control unit 31 adds a fare obtained by multiplying the route distance by the unit price to the initial fare, and multiplies the sum by the coefficient. The coefficients are optionally determined in advance according to the area, the day of the week, and the period of the time, and are stored in the storage unit 32. FIG. 6 shows coefficients examples stored in the storage unit 32. The storage unit 32 stores, for example, a coefficient table 61 for an area X and a coefficient table 62 for an area Y In the coefficient tables 61 and 62, coefficients are stored depending on the day of the week and the period of the time. For example, the control unit 31 may calculate the fare confirmed in advance using the coefficient of the area in which the boarding point is present, or may calculate the fare confirmed in advance using the coefficient of the area in which the alighting point is present. Alternatively, the control unit 31 may partially calculate the fare for each of segments on the route from the boarding point to the alighting point using the corresponding coefficient for each area/each period of the time in which the taxi 13 is predicted to pass through, and add up the fares for all of the segments to obtain the fare confirmed in advance.

The second fare is a previously estimated amount of a pay-as-you-go fare determined based on a time for which the user rides the vehicle and a distance at which the user rides the vehicle. The pay-as-you-go fare is the sum of a fare charged based on a distance of the route from the boarding point to the alighting point, and a fare charged based on a time considering the congestion status of the route. The fare charged based on the distance (distance fare) is calculated by adding, to the initial fare, the additional fare obtained by multiplying the route distance by the unit fare. The fare charged based on the time (time fare) is calculated by multiplying the elapsed time by the unit fare when the taxi 13 has a traveling speed equal to or lower than the reference speed (for example, 10 km/h). The control unit 31 calculates the distance fare for the route from the boarding point to the alighting point, and estimates the time fare to be added to the distance fare, thereby obtaining the second fare. The control unit 31 acquires information on the congestion status of the route from, for example, another server device that collects various pieces of information that the vehicle can detect while traveling, and provides traffic information. The congestion status includes the congestion level and a length of a section where the congestion occurs. The congestion level is information on, for example, the number of vehicles per unit distance section, and the length of traffic having a vehicle-to-vehicle distance less than a predetermined distance. When the traveling speed of the taxi 13 is expected to be equal to or lower than the reference speed due to the congestion in some or all of the sections of the route, the control unit 31 estimates the required time for the taxi 13 to pass through such sections, and estimates the time fare based on the required time. The second fare obtained in this way may be expressed in any numerical range.

Further, the control unit 31 obtains estimation accuracy of the second fare. The estimation accuracy is obtained, for example, based on a history of the congestion status used for estimating the time fare. The control unit 31 stores, for example, the history of the congestion status at a random point on the route in the storage unit 32. The control unit 31 reads, from the storage unit 32, the congestion status for the same time in the past of the section for which the time fare is estimated. The control unit 31 obtains the estimation accuracy in accordance with a frequency at which the section has previously been congested to the extent that it exceeds a random reference. For example, the control unit 31 sets the number of times that congestion exceeding the reference has occurred at the same time in the past fixed period (for example, 2 weeks) as the score of the estimation accuracy. The control unit 31 may, for example, adopt the score, which is obtained by normalizing (for example, based on a 5-point rating scale) the number of times that the congestion exceeding the reference occurs. Alternatively, when it is stored that the congestion exceeding the reference occurs on the same day of the week, the control unit 31 may weight the score corresponding to that day of the week. When the congestion in accordance with the characteristics of the day of the week occurs at a random point on the route, it is possible to improve the reliability of the estimation accuracy by weighting the congestion status by that day of the week.

Further, the control unit 31 may search for several routes from the boarding point to the alighting point, and may obtain the second fare for each route. When the routes are compared, it may be the case that a route having a shorter distance may take a longer time due to heavy congestion such that the pay-as-you-go fare will be more expensive, or it may be the case that a route having a longer distance may take less time such that the pay-as-you-go fare will be cheaper. In such cases, it is possible to increase the options for the user and improve the convenience by showing the second fare, that is, the estimated amount of the pay-as-you-go fare, for each route.

Returning to FIG. 5, in step S508, the server device 12 transmits, to the terminal device 11, information on the first fare, the second fare, and the estimation accuracy of the second fare. The control unit 31 of the server device 12 transmits, to the terminal device 11, the information on the first fare, the second fare, and the estimation accuracy of the second fare, by the communication unit 33. The control unit 21 of the terminal device 11 receives the information on the first fare, the second fare, and the estimation accuracy of the second fare, by the communication unit 23.

In step S510, the terminal device 11 outputs the information on the first fare, the second fare, and the estimation accuracy of the second fare. The control unit 21 of the terminal device 11 displays, for the user, the information on the first fare, the second fare, and the estimation accuracy of the second fare, by the output unit 36. In step S512, the terminal device 11 receives the input by which the user selects the first fare or the second fare. The control unit 21 of the terminal device 11 receives an input of tapping on the image on a display screen, which is made by the user via the input unit 25.

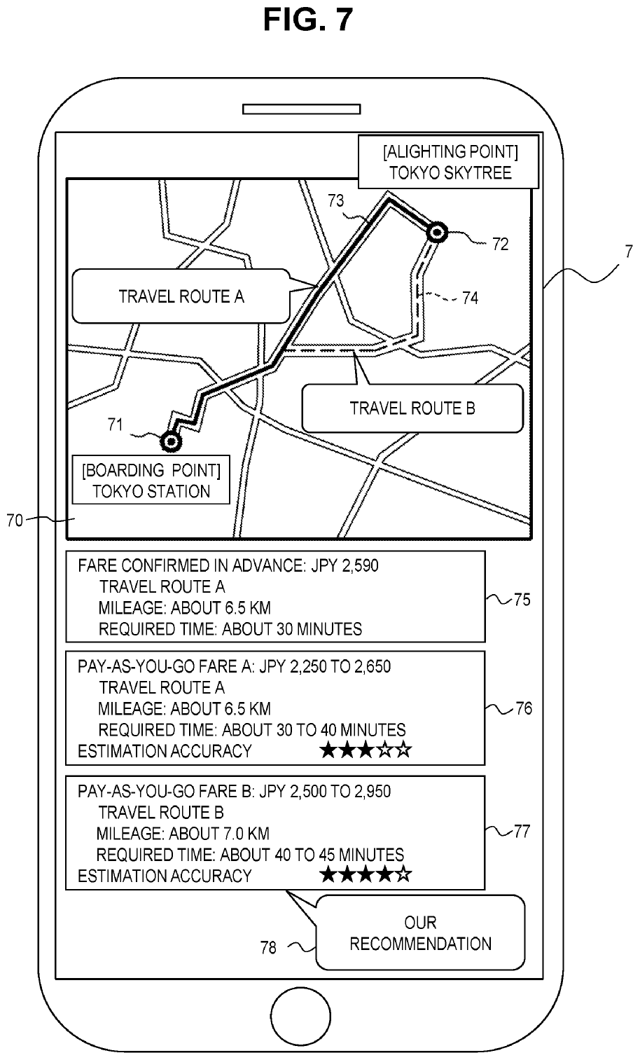

FIG. 7 shows an example of a display/input screen of the terminal device 11. A display screen 7 of the terminal device 11 includes a boarding point 71, an alighting point 72, a route 73 (“travel route A”) and a route 74 (“travel route B”), which are shown on a map 70, as well as a display 75 showing the first fare and displays 76 and 77, each showing the second fare. The display 75 showing the first fare, which is the fare confirmed in advance, includes information such as the fee (JPY 2,590), the travel route A to be traveled on, the mileage (about 6.5 km), and the required time (about 30 minutes). In addition, the display 76 showing the second fare, which is the estimated amount of the pay-as-you-go fare, includes information such as the travel route A to be traveled on, the fee (JPY 2,250 to 2,650), the mileage (about 6.5 km), the required time (30 to 40 minutes), and the estimation accuracy (3 on a 5-point scale). Further, the display 77 showing the second fare, which is another estimated amount of the pay-as-you-go fare, includes information such as the travel route B to be traveled on, the fee (JPY 2,500 to 2,950), the mileage (about 7.0 km), the required time (40 to 45 minutes), and the estimation accuracy (4 on a 5-point scale).

Further, the terminal device 11 may show a display 78 recommending any one of the fares. A case where the second fare of the display 77 is recommended will be described. The recommended display may be balloon text, such as the display 78, or alternatively, may be an image object. Alternatively, the recommendation may be indicated by altering the display 76 or 77 itself. Information for displaying such a recommendation may be generated by the control unit 31 of the server device 12 and transmitted to the terminal device 11 when the fare is calculated in the server device 12, or alternatively, may be generated by the terminal device 11 based on the estimation accuracy of the fare transmitted by the server device 12. For example, it is assumed that the second fare is cheaper than the first fare, and information is generated that recommends the fare having the estimation accuracy equal to or higher than a random reference (for example, at least 4 on a 5-point scale). In addition to the displays 76 and 77 showing the second fares, the terminal device 11 may display text indicating that each fare may differ from the actual fare.

The user checks the information included in the display screen 7, and selects one of the fares by, for example, tapping any of the displays 75, 76, and 77.

Returning to FIG. 5, in step S514, the terminal device 11 transmits, to the server device 12, information on the fare selected by the user. The control unit 21 of the terminal device 11 transmits, to the server device, the information on the fare selected by the user, by the communication unit 23. The control unit 31 of the server device receives the information on the fare selected by the user, by the communication unit 33.

In step S516, the server device 12 generates a service request based on the information of the boarding location, the alighting location, and selected fare, of the user, and transmits the request to the in-vehicle device 40. The control unit 31 of the server device 12 transmits the service request to the in-vehicle device 40, by the communication unit 33. The control unit 41 of the in-vehicle device 40 receives the service request by the communication unit 43.

In step S518, the in-vehicle device 40 generates a service response for the service request. The control unit 41 of the in-vehicle device 40 displays, for a driver, the boarding location and the information on the selected fare, included in the received service request, by the output unit 46, accepts a reply as to whether the driver will accept the service request, as operated by the driver via the input unit 45, and generates the service response based on the reply. When the service is available, the service response includes, for example, an identification number of the taxi 13, and information on a current location of the taxi 13. When the service response indicating that the service is available is generated, the in-vehicle device 40 transmits the service response to the server device 12 in step S520. The control unit 41 of the in-vehicle device 40 transmits the service response to the server device 12 by the communication unit 43. The control unit 31 of the server device 12 receives the service response by the communication unit 33.

In step S522, the server device 12 generates a vehicle dispatch response corresponding to the received service response and transmits the vehicle dispatch response to the terminal device 11. The control unit 31 of the server device 12 calculates, for example, the estimated arrival time at the boarding point based on the current location of the taxi 13. The control unit 31 generates the vehicle dispatch response including, for example, the identification number of the taxi 13, the current location, and the estimated arrival time. The control unit 31 transmits the vehicle dispatch response to the terminal device 11 by the communication unit 33. The control unit 21 of the terminal device 11 receives the vehicle dispatch response by the communication unit 23.

In step S524, the terminal device 11 outputs the vehicle dispatch response to the user. The control unit 21 of the terminal device 11 displays the vehicle dispatch response to the user by the output unit 36. For example, the estimated arrival time of the taxi 13 to the boarding point is displayed together with the text information indicating that “the vehicle is dispatched.” When the taxi 13 arrives at the boarding point and the user boards the taxi 13, the taxi 13 travels toward the alighting point.

Depending on whether the user selects the first fare or the second fare in step S512, a billing process of either step S526 or step S530 is executed, and the other is omitted.

When the user selects the first fare in step S512 and the vehicle is dispatched based on the selection, the server device 12 executes the billing process based on the first fare in step S526. For example, the control unit 31 of the server device 12 charges the user for the first fare by sending a billing processing request to another server device that manages a financial account owned by the user. The billing process includes any electronic payment method such as remittance, credit card, and electronic money. In this case, the billing process in step S526 can be executed at a random timing, for example, after the server device 12 receives the selected fare in step S514. For example, the server device 12 may execute the billing process when receiving the service response from the in-vehicle device 40 of the taxi 13.

On the other hand, when the user selects the second fare in step S512 and the vehicle is dispatched based on the selection, the server device 12 receives, from the in-vehicle device 40 of the taxi 13, a notification that the service is completed in step S528 before executing the billing process for the second fare in step S530. The in-vehicle device 40 of the taxi 13 transmits, to the server device 12, the notification that the service is completed when the taxi 13 arrives at the alighting point or in response to the user request, as operated by the driver. The control unit 41 of the in-vehicle device 40 generates the notification that the service is completed as operated by the driver via the input unit 45. At this time, the control unit 41 calculates the pay-as-you-go fare based on the actual mileage and the time taken in the section where the taxi 13 runs at a speed equal to or lower than the reference speed. The control unit 41 generates the notification that the service is completed, which also includes the calculated fare. The control unit 41 transmits the notification that the service is completed to the server device 12 by the communication unit 43. The control unit 31 of the server device 12 executes, when the notification that the service is completed is received by the communication unit 33, the billing process based on the fare included in the notification.

As stated above, according to the present embodiment, since the information processing system 10 displays the fare such that the user can select either the estimated amount of the pay-as-you-go fare or the fare confirmed in advance, the user can choose any one of the fare confirmed in advance or the pay-as-you-go fare, by referring to the estimated amount of the pay-as-you-go fare. When the user predicts whether the actual pay-as-you-go fare would be higher or lower than the fare confirmed in advance based on the estimated amount, the user can select the fare confirmed in advance if he/she determines that the pay-as-you-go fare is likely to be higher than the fare confirmed in advance, and otherwise, the user can select the pay-as-you-go fare if he/she determines that the pay-as-you-go fare is likely to be lower than the fare confirmed in advance. Therefore, the user can select the optimal fare. Furthermore, the estimation accuracy or the recommended information allows the user to select the optimal fare with higher accuracy. Consequently, the convenience of the vehicle dispatch service can be improved.

In the embodiment stated above, the processing or control program that defines the operations of the terminal device 11 and the in-vehicle device 40 may be stored in the storage unit 42 of the server device 12 or in a storage unit of another server, and be downloaded to each device via the network 14, or alternatively, may be stored in a computer-readable non-transient recording/storage medium, which is portable and read by each device.

The present disclosure is not limited to the embodiments stated above. For example, a plurality of blocks described in the block diagram may be integrated, or alternatively, a single block may be divided into several blocks. Instead of executing the steps described in the flowchart in chronological order according to the description, the steps may be executed in parallel or in a different order depending on the processing capability of the device executing the steps, or as necessary. Other changes or modifications can be made without departing from the spirit of the present disclosure.

What is claimed is:

1. A server device comprising:
a communication unit; and
a control unit configured to transmit and receive information to and from a terminal device by the communication unit,
wherein the control unit is configured to:
receive, from the terminal device, a request for vehicle dispatch including a specified section for where a user rides a vehicle;
transmit, to the terminal device, information on a first fare determined before the user rides the vehicle and information on a second fare estimated before the user rides the vehicle to cause the terminal device to output information for prompting the user to select the first fare or the second fare, the first fare and the second fare being associated with the ride; and
dispatch the vehicle when any one of the first fare and the second fare is selected.

2. The server device according to claim 1, wherein the first fare is a fare calculated by a predetermined method based on information on the section.

3. The server device according to claim 1, wherein the second fare is an estimated amount of a pay-as-you-go fare determined based on a time for which the user rides the vehicle and a distance at which the user rides the vehicle.

4. The server device according to claim 1, wherein the control unit is configured to, in a case where the first fare is selected, execute a payment process when the vehicle is dispatched, or in a case where the second fare is selected, execute the payment process when the user alights from the vehicle.

5. The server device according to claim 1, wherein the control unit is configured to derive the second fare by referring to a congestion status of a route on which the user rides the vehicle.

6. The server device according to claim 5, wherein the control unit is configured to derive the second fare by referring to a history of the congestion status.

7. The server device according to claim 5, wherein the control unit is configured to transmit, to the terminal device, information on an estimation accuracy of the second fare to cause the terminal device to output the information on the estimation accuracy.

8. The server device according to claim 7, wherein the control unit is configured to, in a case where the second fare is cheaper than the first fare, transmit, to the terminal device, information for recommending the second fare to cause the terminal device to output the information for recommending the second fare.

9. The server device according to claim 8, wherein the control unit is configured to, in a case where the second fare is selected, transmit, to the terminal device, information indicating that there is a possibility that a pay-as-you-go fare confirmed after the user rides the vehicle will exceed the first fare to cause the terminal device to output the information indicating the possibility.

10. An information processing system comprising:
the server device according to claim 1; and
a terminal device.

11. A program of a terminal device which, when being executed by the terminal device that communicates with a server device, causes the terminal device to:
transmit, to the server device, a request for vehicle dispatch with a specified section where a user rides a vehicle;
receive, from the server device, information on a first fare determined before the user rides the vehicle and information on a second fare estimated before the user rides the vehicle;
output information for prompting the user to select the first fare or the second fare;
receive, from the user, an input for selecting the first fare or the second fare; and
transmit, to the server device, information on the selected fare to cause the server device to dispatch the vehicle.

12. An operation method of a server device that transmits and receives information to and from a terminal device, the operation method comprising:
receiving, from the terminal device, a request for vehicle dispatch with a specified section where a user rides a vehicle;
transmitting, to the terminal device, for the vehicle dispatch, information on a first fare determined before the user rides the vehicle and information on a second fare estimated before the user rides the vehicle to cause the terminal device to output information for prompting the user to select the first fare or the second fare; and
dispatching the vehicle when any one of the fares is selected.

13. The operation method according to claim 12, wherein the first fare is a fare calculated by a predetermined method based on information on the section.

14. The operation method according to claim 12, wherein the second fare is an estimated amount of a pay-as-you-go fare determined based on a time for which the user rides the vehicle and a distance at which the user rides the vehicle.

15. The operation method according to claim 12, further comprising:
in a case where the first fare is selected, executing a payment process when the vehicle is dispatched, or in a case where the second fare is selected, executing the payment process when the user alights from the vehicle.

16. The operation method according to claim 12, wherein the second fare is derived referring to a congestion status of a route on which the user rides the vehicle.

17. The operation method according to claim 16, wherein the second fare is derived referring to s history of the congestion status.

18. The operation method according to claim 16, further comprising:
transmitting, to the terminal device, information on an estimation accuracy of the second fare to cause the terminal device to output the information on the estimation accuracy.

19. The operation method according to claim 18, further comprising:
transmitting, to the terminal device, in a case where the second fare is cheaper than the first fare, information for recommending the second fare to cause the terminal device to output the information for recommending the second fare.

20. The operation method according to claim 19, further comprising:
transmitting, to the terminal device, in a case where the second fare is selected, information indicating that it is possible that a pay-as-you-go fare confirmed when the user alights from the vehicle will exceed the first fare to cause the terminal device to output the information indicating the possibility.
